(19) United States
(12) Patent Application Publication
(10) Pub. No.: US 2023/0060622 A1
(43) Pub. Date: Mar. 2, 2023

(54) METHODS AND DEVICES FOR DEFLAVORING, FLAVORING, AND REFLAVORING CANNABIS PLANT MATTER

(71) Applicant: Float Technologies LLC, Los Angeles, CA (US)

(72) Inventor: Jeffrey Alan Danzer, Los Angeles, CA (US)

(21) Appl. No.: 17/407,254

(22) Filed: Aug. 20, 2021

(51) Int. Cl. A23L 5/30; A23L 5/20

(52) U.S. Cl. CPC A23L 5/30; A23L 5/23; A23L 5/273; A23L 27/88

(57) ABSTRACT

Methods of cannabis deflavoring, cannabis reflavoring, and combinations thereof are described. In some embodiments, the methods described herein allow the deflavored cannabis plant matter to absorb an essence of the at least one flavoring agent without the cannabis plant matter directly contacting the at least one flavoring agent. Cannabis flavoring devices are further described. In some embodiments, the cannabis flavoring device is configured to allow the cannabis plant matter to absorb an essence of the at least one flavoring agent without the cannabis plant matter directly contacting the at least one flavoring agent.

### FIELD

The following relates to methods of cannabis deflavoring, cannabis reflavoring, and combinations thereof. The following further relates to cannabis flavoring devices.

### BACKGROUND

Cannabis has been widely consumed for several thousand years dating back to ancient times. As long as the cannabis plant has existed, its distinctive aroma has been noted by many. While some users enjoy the aroma, many do not, turning those users off from consuming cannabis in smokable form. Some who do not enjoy the aroma of cannabis would be willing to consume cannabis in edible form. However, the components of the cannabis plant that contribute to its distinctive smell also provide an aftertaste to foods cooked with cannabis.

With cannabis now becoming legal in several jurisdictions around the world, there is a need for a process that can reduce the aroma and taste of cannabis to increase its appeal to a broader consumer base. There is also a need for a process or device that can successfully infuse flavoring agents into the cannabis plant without introducing chemicals. It would also be helpful to have a process or device that, in addition to reducing the aroma and taste of cannabis, can concurrently remove any contaminants and impurities (e.g., fertilizers, soil additives, pesticides), thereby resulting in a healthier form of ingestible cannabis.

### SUMMARY

To solve at least the above technical problems, methods of cannabis deflavoring, cannabis reflavoring, and combinations thereof are described. In addition, cannabis flavoring devices are further described.

A cannabis deflavoring process is described. One or more embodiments of the cannabis deflavoring process include obtaining cannabis plant matter, bathing the cannabis plant matter in a solution, where the solution comprises bicarbonate ions and at least one acid, steeping the cannabis plant matter in hot water, quenching the cannabis plant matter in cold water, mechanically removing excess moisture from the cannabis plant matter, heating the cannabis plant matter under pressure in a presence of water, and heat drying the cannabis plant matter.

A cannabis reflavoring process is described. One or more embodiments of the cannabis reflavoring process include obtaining deflavored cannabis plant matter, obtaining at least one flavoring agent, infusing at least one portion of the cannabis flavoring device with the flavoring agent, placing the deflavored cannabis plant matter in the cannabis flavoring device, and maintaining the deflavored cannabis plant matter in the cannabis flavoring device for a sufficient time to allow the deflavored cannabis plant matter to absorb an essence of the at least one flavoring agent, where the deflavored cannabis plant matter does not directly contact the at least one flavoring agent.

A cannabis deflavoring and reflavoring process is described. One or more embodiments of the cannabis deflavoring and reflavoring process include a deflavoring stage comprising obtaining cannabis plant matter, bathing the cannabis plant matter in a solution, where the solution comprises bicarbonate ions and at least one acid, steeping the cannabis plant matter in hot water, quenching the cannabis plant matter in cold water, mechanically removing excess moisture from the cannabis plant matter, heating the cannabis plant matter under pressure in a presence of water, and heat drying the cannabis plant matter, where the deflavoring stage results in deflavored cannabis and a reflavoring stage comprising obtaining the deflavored cannabis plant matter, obtaining at least one flavoring agent, infusing at least one portion of the cannabis flavoring device with the at least one flavoring agent, placing the deflavored cannabis plant matter in the cannabis flavoring device, and maintaining the deflavored cannabis plant matter in the cannabis flavoring device for a sufficient time to allow the deflavored cannabis plant matter to absorb an essence of the at least one flavoring agent, where the deflavored cannabis plant matter does not directly contact the at least one flavoring agent during the cannabis reflavoring stage.

A cannabis flavoring device is further described. One or more embodiments of the cannabis flavoring device include a housing, where at least one portion of the housing is configured to house cannabis plant matter, an at least one side wall, and an at least one top surface, at least one bottom surface, or a combination thereof, where at least one portion of the cannabis flavoring device is configured to be infused with at least one flavoring agent, and where the cannabis flavoring device is configured to allow the cannabis plant matter to absorb an essence of the at least one flavoring agent without the cannabis plant matter directly contacting the at least one flavoring agent.

### BRIEF DESCRIPTION OF THE DRAWINGS

FIG. 1 shows a first example flavoring device according to aspects of the present disclosure.

FIG. 2 shows second example flavoring device according to aspects of the present disclosure.

FIG. 3 shows an example of a cannabis deflavoring process or a cannabis deflavoring stage of a cannabis deflavoring and reflavoring process according to aspects of the present disclosure.

FIG. 4 shows an example of a cannabis reflavoring process or a cannabis reflavoring stage of a cannabis deflavoring and reflavoring process according to aspects of the present disclosure.

### DETAILED DESCRIPTION

A cannabis deflavoring process is described according to some aspects of the present disclosure. As used herein a “cannabis deflavoring process” is any method or process that decreases an aroma of cannabis plant matter, decreases a taste of cannabis plant matter, or a combination thereof.

One or more embodiments of the cannabis deflavoring process include obtaining cannabis plant matter. As used herein “cannabis plant matter” is any form of plant matter that can be obtained from cannabis, without limitation. In some examples, the cannabis plant matter comprises cannabis flower, hemp, kief, stems, seeds, or any combination thereof. In some examples, the cannabis plant matter comprises at least one cannabinoid. In some examples, the at least one cannabinoid comprises tetrahydrocannabinol (THC), cannabidiol (CBD), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), and cannabigerol monomethylether (CBGM), or a combination thereof. In certain cases, the cannabis plant matter comprises at least one terpene. The at least one terpene may, in some implementations, comprise limonene, pinene, myrcene, linalool, beta caryophyllene, terpineol, terpinolene, or a combination thereof.

In some embodiments, the method comprises bathing the cannabis plant matter in a solution. In some embodiments, the solution comprises carbon dioxide bubbles. In certain implementations, the solution may comprise reactants, that when combined, form carbon dioxide bubbles. For instance, in certain implementations, the solution comprises bicarbonate ions and at least one acid. In some examples, the at least one acid is at least one organic acid. In certain examples, the at least one acid comprises lactic acid, acetic acid, citric acid, oxalic acid, malic acid, tartaric acid, or any combination thereof. In some examples, the acetic acid is apple cider vinegar. In some implementations, a source of the bicarbonate ions is a bicarbonate salt. In some examples, the bicarbonate salt is sodium bicarbonate, potassium bicarbonate, ammonium bicarbonate, or any combination thereof. Some examples of the cannabis deflavoring process further include forming the solution by mixing water with the at least one acid and a bicarbonate salt. In some examples, the solution is formed prior to bathing the cannabis plant matter in solution. In certain examples, the solution is formed by mixing water with the at least one acid, thereby forming a mixture, and adding a bicarbonate salt to the mixture. In some examples, the water is mixed with the at least one acid in a volumetric ratio of the at least one acid to the water of: 1:3 to 1:1, 1:2 to 1:1, 1:3 to 1:2, or any combination thereof. In some examples, the bicarbonate salt is added to the mixture in a volumetric ratio of the bicarbonate salt to the mixture of: 1:50 to 1:10, 1:40 to 1:10, 1:30 to 1:10, 1:20 to 1:10, 1:50 to 1:20, 1:50 to 1:30, 1:50 to 1:40, 1:40 to 1:20, or any combination thereof. In certain examples, the solution is formed by mixing water solution by mixing water with a bicarbonate salt, thereby forming a mixture, and adding at least one acid to the mixture. In some examples, the water is mixed with the bicarbonate salt in a volumetric ratio of the bicarbonate salt to the water of: 1:50 to 1:10, 1:40 to 1:10, 1:30 to 1:10, 1:20 to 1:10, 1:50 to 1:20, 1:50 to 1:30, 1:50 to 1:40, 1:40 to 1:20, or any combination thereof. In some examples, the at least one acid is added to the mixture in a volumetric ratio of the at least one acid to the mixture of: 1:3 to 1:1, 1:2 to 1:1, 1:3 to 1:2, or any combination thereof.

In some examples, the cannabis deflavoring process comprises steeping the cannabis plant matter in hot water. As used herein “hot water” refers to water having a temperature of at least 100° F. at ambient pressure. In some examples, the hot water has a temperature ranging from 155° F. to 255° F., 175° F. to 255° F., 200° F. to 255° F., 225° F. to 255° F., 250° F. to 255° F., 155° F. to 250° F., 155° F. to 225° F., 155° F. to 200° F., 155° F. to 175° F., 175° F. to 225° F., or any combination thereof. In some examples, the hot water is boiling water. As used herein “boiling water” refers to water having a temperature of at least 212° F. at ambient pressure. In some examples, the steeping is performed for 1 to 15 minutes, 5 to 15 minutes, 10 to 15 minutes, 1 to 10 minutes, 1 to 5 minutes, 5 to 10 minutes, or any combination thereof. In some examples, the steeping is performed in a pot, a kettle, a vessel, a boiler, a steamer, or any combination thereof.

In some examples, the cannabis deflavoring process comprises quenching the cannabis plant matter in cold water. As used herein, “cold water” is water having a temperature of 60° F. or less at ambient pressure. In some examples, the cold water has a temperature ranging from 30° F. to 60° F., 40° F. to 60° F., 50° F. to 60° F., 30° F. to 50° F., 30° F. to 40° F., 40° F. to 50° F., or any combination thereof. In some examples, the cold water is ice water. As used herein, “ice water” is water that comprises ice. Some examples of the cannabis deflavoring process further include maintaining the cannabis plant matter in the cold water for 0.1 hours to 100 hours, 1 hour to 100 hours, 10 hours to 100 hours, 25 hours to 100 hours, 50 hours to 100 hours, 0.1 hours to 50 hours, 0.1 hours to 25 hours, 0.1 hours to 10 hours, 1 hour to 50 hours, 10 hours to 25 hours, or any combination thereof. In some examples, the cannabis plant matter is transferred directly from the hot water to the cold water during the quenching step.

Some embodiments of the cannabis deflavoring process may further comprise mechanically removing excess moisture from the cannabis plant matter. In some examples, mechanically removing excess moisture from the cannabis plant matter comprises agitating the cannabis plant matter, hand drying the cannabis plant matter, air drying the cannabis plant matter, or any combination thereof. In some examples, the agitating comprises shaking the cannabis plant matter, striking the cannabis plant matter, centrifuging the cannabis plant matter, sieving the cannabis plant matter, panning the cannabis plant matter, stirring the cannabis plant matter, or any combination thereof. In some examples, the mechanically removing of excess moisture from the cannabis plant matter is performed using a strainer, a sieve, a centrifuge, a filter, an air blower, a fan, a towel, or any combination thereof. In some examples, centrifuging the cannabis plant matter is performed at a rotational speed of 100 rpm to 1000 rpm, 200 rpm to 1000 rpm, 500 rpm to 1000 rpm, 100 rpm to 500 rpm, 100 rpm to 200 rpm, 200 rpm to 500 rpm, or any combination thereof. In some examples, mechanically removing excess moisture may be performed before, during, or after any step of the cannabis deflavoring process. For instance, the mechanically removing excess moisture may also be performed during the bathing, after the bathing, or any combination thereof.

In certain implementations, the cannabis deflavoring process further comprises heating the cannabis plant matter under pressure in a presence of water. In some examples, heating the cannabis plant matter under pressure in the presence of water comprises obtaining a vessel, where the vessel comprises a chamber and a porous barrier, adding water to the chamber of the vessel, adding the cannabis plant matter to the vessel, such that the cannabis plant matter is separated from the water in the chamber by the porous barrier, heating the vessel to an operating temperature, pressurizing the vessel to an operating pressure, maintaining the vessel at the operating pressure for a predetermined time period, releasing pressure from the vessel, and removing the cannabis plant matter from the vessel. In some examples, the vessel is a pressure cooker. In certain implementations, the vessel is a kettle, a wok, a pressure canner, or any combination thereof. In some examples, the porous barrier is a mesh carrier, and the cannabis plant matter is placed within the mesh carrier.

In some examples, the operating temperature of the vessel is from 100° F. to 350° F., 200° F. to 350° F., 300° F. to 350° F., 100° F. to 300° F., 100° F. to 200° F., 200° F. to 300° F. or any combination thereof. In some examples, the operating pressure of the vessel is from 1 psi to 20 psi, 10 psi to 20 psi, 15 psi to 20 psi, 1 psi to 15 psi, 1 psi to 10 psi, 10 psi to 15 psi, or any combination thereof. In some examples, the predetermined time period is from 1 minute to 20 minutes, 5 minutes to 20 minutes, 15 minutes to 20 minutes, 1 minute to 15 minutes, 1 minute to 10 minutes, 1 minute to 10 minutes, or any combination thereof. In some examples, the amount of water added depends on the size of the vessel and is added in an amount sufficient that the cannabis plant matter will not burn for the duration of the predetermined time period.

In some examples, releasing pressure from the vessel comprises opening a valve on the vessel. In certain implementations releasing pressure from the vessel causes a pressure gradient. The pressure gradient may cause steam from the vessel to be released into the air. This release of steam can, in some implementations, free surface contaminants, such as but not limited to, microbes, heavy metals, fungi, fungicides, aromatics, bacteria, pesticides, and fertilizers, from the cannabis plant matter.

In certain examples, conditions (e.g., operating temperature, operating pressure, water content, the predetermined time until venting, among others) of the vessel may be adjusted to maximize the presence of compounds of interest, while minimizing undesirable compounds.

As used herein, “compounds of interest” are compounds that are sometimes, but not always, desirable in cannabis plant matter. Compounds of interest may be targeted in high amounts, low amounts, trace amounts, or in no detectable amounts without departing from the present disclosure. In some examples, some compounds of interest may be targeted in high amounts, with others targeted in low amounts. Some exemplary compounds of interest and their respective boiling points at ambient pressure are shown below in Table 1. As known in the art, pressure may be adjusted to alter the boiling points tabulated below.

TABLE 1

| | | Boiling Point at |
|---|---|---|
| Compound of Interest | Category | Ambient Pressure |
| tetrahydrocannabinol (THC) | cannabinoid | 315° F. |
| cannabidiol (CBD) | cannabinoid | 356° F. |
| cannabinol (CBN) | cannabinoid | 365° F. |
| limonene | terpene | 349° F. |
| pinene | terpene | 311° F. |
| myrcene | terpene | 333° F. |

As used herein, “undesirable compounds” are compounds that are generally recognized by those skilled in the art as contaminants. Some examples of undesirable compounds include, but are not limited to, fungi, aromatics, bacteria, pesticides, and fertilizers. In some implementations, minimizing undesirable compounds in the deflavored cannabis plant matter may remediate cannabis plant matter that would otherwise comprise unacceptable levels (e.g., in excess of regulatory requirements) of undesirable compounds. Some exemplary undesirable compounds and their respective boiling points are shown below in Table 2.

TABLE 2

| | | Boiling Point at |
|---|---|---|
| Undesirable Compound | Category | Ambient Pressure |
| Benzene | aromatic | 176° F. |
| toluene | aromatic | 230° F. |
| chlorpyrifos | pesticide | 320° F. |
| cyclobutanil | fungicide | 400° F. |

In certain embodiments, the cannabis deflavoring process comprises heat drying the cannabis plant matter. In some examples, heat drying the cannabis plant matter is performed at a temperature sufficient to decarboxylate the cannabis plant matter. In some examples, the temperature sufficient to decarboxylate the cannabis plant matter is from 100° F. to 300° F., 200° F. to 300° F., 250° F. to 300° F., or any combination thereof. In some examples, the heat drying may be performed at above or below the temperature sufficient to decarboxylate the cannabis plant matter. In some examples, heat drying is performed by an oven, a dehydrator, a barbecue, a hopper dryer, an air dryer, a vaporizer, a sauna, or any combination thereof. In some examples, heat drying is performed for 1 hour to 5 hours, 2 hours to 5 hours, 3 hours to 5 hours, 4 hours to 5 hours, 1 hour to 4 hours, 1 hours to 3 hours, 1 hour to 2 hours, 2 hours to 4 hours, or any combination thereof.

Some examples of the cannabis deflavoring process further include dissolving the deflavored cannabis plant matter in at least one solvent. In some examples, dissolving the deflavored cannabis plant matter in at least one solvent may also occur after the reflavoring process described below. In some implementations dissolving the deflavored cannabis plant matter in at least one solvent may allow the deflavored cannabis plant matter or reflavored plant matter to be used for cooking, vaporizing (e.g., as a “vape liquid”), as ingredients in beverages (either alcoholic or non-alcoholic), as a tincture, in pharmaceuticals (e.g., as a pill or a patch), as a topical formulation (e.g., a cream, a lotion, a gel), or any combination thereof. In some examples, the at least one solvent comprises butter, ethanol, at least one oil, animal fat, glycerin, propylene glycol, or any combination thereof. In some examples, the at least one oil is at least one cooking oil comprising sesame oil, olive oil, vegetable oil, coconut oil, peanut oil, truffle oil, sunflower oil, corn oil, canola oil, hazelnut oil, soy bean oil, or any combination thereof.

A cannabis reflavoring process is described according to some aspects of the present disclosure. As used herein a “cannabis reflavoring process” is any method or process that reintroduces a flavor or aroma into deflavored cannabis plant matter. In some examples, the cannabis reflavoring process may be repurposed as a cannabis flavoring process by replacing deflavored cannabis plant matter with cannabis plant matter that has not been deflavored. Accordingly, any step of a cannabis reflavoring process may be replaced with a step of a cannabis flavoring process without departing from the scope of the present disclosure.

One or more embodiments of the cannabis reflavoring process include obtaining deflavored cannabis plant matter. In some examples, the deflavored cannabis plant matter may be obtained from the deflavoring process described above. In some examples, the deflavored cannabis plant matter may be obtained commercially.

In some examples, the cannabis reflavoring process comprises obtaining at least one flavoring agent. As used herein, “a flavoring agent” is any component that, when placed in sufficiently close contact with cannabis plant matter, can impart an aroma, taste, or, combination thereof to the cannabis plant matter. In some examples, the at least one flavoring agent comprises at least one essential oil, amyl acetate, benzaldehyde, ethyl butyrate, methyl anthranilate, methyl salicylate, fumaric acid, or any combination thereof. In some examples, the at least one essential oil comprises lavender oil, cinnamon oil, eucalyptus oil, rose oil, clove oil, tea tree oil, oregano oil, rosemary oil, peppermint oil, or any combination thereof.

Some implementations of the cannabis reflavoring process include infusing at least one portion of a cannabis flavoring device with the at least one flavoring agent. As used herein a “flavoring device” is any device that is configured to impart an aroma, taste, or combination thereof to cannabis plant matter or deflavored cannabis plant matter. In some examples, the at least one portion of the cannabis flavoring device that is infused with at least one flavoring agent comprises at least one surface of the flavoring device. In some examples, the at least one surface comprises the at least one side wall, the at least one top surface, the at least one bottom surface, or any combination thereof. In some examples, infusing the at least one portion of the cannabis flavoring device includes coating the at least one portion, impregnating the at least one portion, placing an insert on the at least one portion, spraying the at least one portion, applying a powder to the at least one portion, or any combination thereof.

In some examples, the cannabis flavoring device comprises a material having a specific water permeability. Water permeability, may in some examples, serve as a proxy parameter for the adsorption/desorption capability of the flavoring device. A surface of a flavoring device with a higher water permeability may therefore, in some implementations, adsorb and desorb the at least one flavoring agent more readily, so as to allow the at least one flavoring agent to diffuse throughout the flavoring device during operation. In certain implementations, the flavoring device may have a water permeability ranging from 1×10⁻⁸ cm²/s to 1×10⁻⁶ cm²/s at 30° C., 1×10⁻⁷ cm²/s to 1×10⁻⁶ at 30° C., 1×10⁻⁸ cm²/s to 1×10⁻⁷ cm²/s at 30° C., or any combination thereof. In some examples, materials with suitable water permeabilities may comprise polystyrene (PS), polypropylene (PP), polyethylene (PE), high density polyethylene (HDPE), polyvinyl alcohol (PVA), polyvinyl acetate (PVAc), polyvinyl butyral (PVB), poly methyl methacrylate (PMMA), polyvinyl chloride (PVC), or any combination thereof. Further examples of materials that may have suitable water permeability are described in Keller et al., Water Vapor Permeation in Plastics, U.S. Department of Homeland Security Domestic Nuclear Detection Office, January 2017 Revision 1, which is incorporated herein by reference in its entirety for all purposes.

Some examples of the reflavoring process include placing the deflavored cannabis plant matter in the cannabis flavoring device. The placing of the deflavored cannabis plant matter in the cannabis flavoring device, may in some implementations, be performed manually or automatically (e.g., using robotics.)

Some examples, include maintaining the deflavored cannabis plant matter in the cannabis flavoring device for a sufficient time to allow the deflavored cannabis plant matter to absorb an essence of the at least one flavoring agent. In some examples, the sufficient time is from 0.1 hours to 100 hours, 1 hour to 100 hours, 10 hours to 100 hours, 25 hours to 100 hours, 50 hours to 100 hours, 0.1 hours to 50 hours, 0.1 hours to 25 hours, 0.1 hours to 10 hours, 1 hour to 50 hours, 10 hours to 25 hours, or any combination thereof.

In some examples, the deflavored cannabis plant matter does not directly contact the at least one flavoring agent during the cannabis flavoring process. Avoiding direct contact of the delavored cannabis plant matter with the at least one flavoring agent, may in some embodiments, avoid components of the at least one flavoring agent from being ingested, while nonetheless imparting an essence of the at least one flavoring agent unto the deflavored cannabis plant matter.

A cannabis deflavoring and reflavoring process is also described. One or more embodiments of the deflavoring and reflavoring process include a deflavoring stage and a reflavoring stage. One or more embodiments of the deflavoring stage may comprise performing at least one step of the deflavoring process described above. One or more embodiments of the reflavoring stage may comprise performing at least one step of the reflavoring process described above. In some embodiments, the deflavoring stage comprises obtaining cannabis plant matter, bathing the cannabis plant matter in a solution (where the solution comprises bicarbonate ions and at least one acid), steeping the cannabis plant matter in hot water, quenching the cannabis plant matter in cold water, mechanically removing excess moisture from the cannabis plant matter, heating the cannabis plant matter under pressure in a presence of water, and heat drying the cannabis plant matter. In some examples, the deflavoring stage results in deflavored cannabis plant material. In some embodiments, the reflavoring stage comprises obtaining the deflavored cannabis plant matter, obtaining at least one flavoring agent, infusing at least one portion of the cannabis flavoring device with the at least one flavoring agent, placing the deflavored cannabis plant matter in the cannabis flavoring device, and maintaining the deflavored cannabis plant matter in the cannabis flavoring device for a sufficient time to allow the deflavored cannabis plant matter to absorb an essence of the at least one flavoring agent. In some examples, the deflavored cannabis plant matter does not directly contact the at least one flavoring agent during the cannabis reflavoring stage.

In some embodiments, the reflavored cannabis plant matter or the deflavored cannabis plant matter may be stored in an air-tight container, such as, but not limited to a plastic container or a vacuum-sealed bag. Keeping the reflavored cannabis plant matter or the deflavored cannabis plant matter in an air-tight container may reduce a likelihood that the reflavored cannabis plant matter or the deflavored cannabis plant matter would become infused with an essence of a surrounding storage container.

On the other hand, in one or more implementations, one may desire the reflavored cannabis plant matter or the deflavored cannabis plant matter to take on an essence of the surrounding storage container. Accordingly, in some examples, the reflavored cannabis plant matter or the deflavored cannabis plant matter may be strategically placed in a storage container having the desired essence. For example, the reflavored cannabis plant matter or the deflavored cannabis plant matter may be placed in at least one whiskey barrel, at least one cigar humidor, at least one coffee bean canister, or any combination thereof to take on the flavor of whiskey, tobacco, or coffee, respectively. In some of the aforementioned examples, the storage container may serve a dual function as both the at least one flavoring agent and the flavoring device. In some of the aforementioned examples, the storage container may supplement any exemplary flavoring agent or flavoring device described herein. Conversely, in some examples, any flavoring device described herein may be repurposed as a storage container.

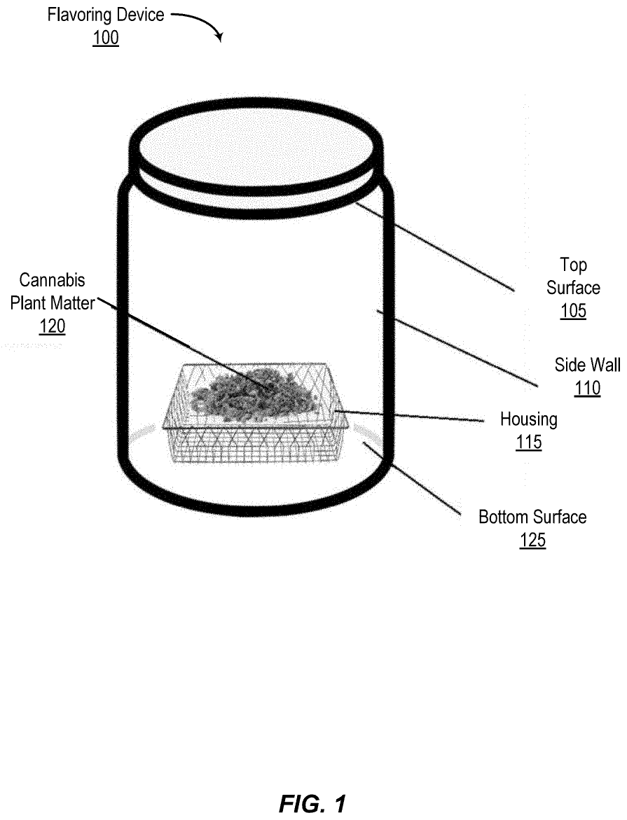

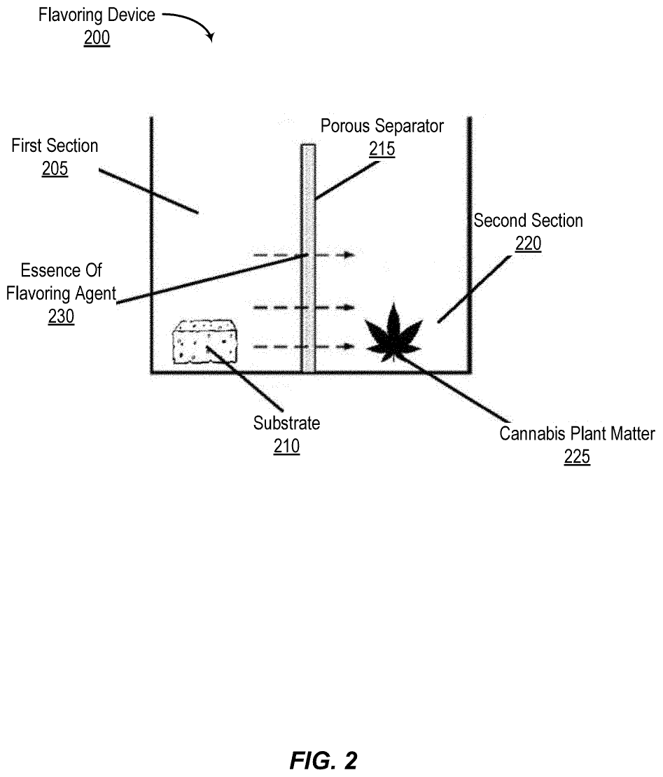

FIG. 1 shows a non-limiting example of an exemplary cannabis flavoring device 100 according to aspects of the present disclosure. Flavoring device 100 is an example of, or includes aspects of, the corresponding element described with reference to FIG. 2.

In some examples, the flavoring device 100 comprises a plastic container, a glass container, a metal container, a wood container, a ceramic container, or any combination thereof. In some examples, the cannabis flavoring device 200 is ultraviolet (UV) resistant. In some examples, the cannabis flavoring device 100 is spherical, semispherical, or cylindrical and comprises a side wall. 110 In some examples, the infused at least one portion is the side wall 110. In some examples, the cannabis flavoring device is in a shape of a three-dimensional polygon comprising at least three side walls 110. In some examples, the infused at least one portion is at least one of the at least three side walls 110.

In one embodiment, flavoring device 100 includes top surface 105, side wall 110, housing 115, and bottom surface 125. In one embodiment, housing 115 includes cannabis plant matter 120. Cannabis plant matter 120 is an example of, or includes aspects of, the corresponding element described with reference to FIG. 2. One or more embodiments of the cannabis flavoring device 100 include a housing 115, at least one side wall 110, at least one top surface 105, at least one bottom surface 125, or a combination thereof. In some examples, at least one portion of the housing 115 is configured to house cannabis plant matter 120. In some examples, at least one portion of the cannabis flavoring device 100 is configured to be infused with at least one flavoring agent, and the cannabis flavoring device 100 is configured to allow the cannabis plant matter 120 to absorb an essence of the at least one flavoring agent without the cannabis plant matter 120 directly contacting the at least one flavoring agent. In some examples, the housing 115 comprises a carrier, where the carrier is configured to house the cannabis plant matter 120.

FIG. 2 shows an additional non-limiting example of a second example flavoring device 200 according to aspects of the present disclosure. Flavoring device 200 is an example of, or includes aspects of, the corresponding element described with reference to FIG. 1.

One or more embodiments of the cannabis flavoring device 200 include a housing, at least one side wall, at least one top surface, at least one bottom surface, or a combination thereof. In some examples, at least one portion of the housing is configured to house cannabis plant matter 225. In some examples, at least one portion of the cannabis flavoring device 200 is configured to be infused with at least one flavoring agent, and the cannabis flavoring device 200 is configured to allow the cannabis plant matter 225 to absorb an essence of the at least one flavoring agent 230 (as indicated by the arrows) without the cannabis plant matter 225 directly contacting the at least one flavoring agent.

In one embodiment, flavoring device 200 includes first section 205, porous separator 215, second section 220, and essence of the at least one flavoring agent 230. In one embodiment, first section 205 includes substrate 210. In one embodiment, second section 220 includes cannabis plant matter 225. Cannabis plant matter 225 is an example of, or includes aspects of, the corresponding element described with reference to FIG. 1.

In some examples, the cannabis flavoring device 200 comprises a porous separator 215, where the porous separator 215 divides the cannabis flavoring device 200 into a first section 205 and a second section 220. In some examples, the first section 205 comprises a substrate 210, the second section 220 comprises the housing, and the substrate 210 is configured to be infused with the at least one flavoring agent. In some examples, the porous separator 215 is configured to allow an essence of the at least one flavoring agent 230 to diffuse from the first section 205 to the second section 220 without the at least one flavoring agent directly contacting the cannabis plant matter 225.

In some examples, the porous separator 215 comprises a membrane, a coffee filter, perforated paper, a mesh, a fabric, or any combination thereof. In some examples, the infused at least one portion of the cannabis flavoring device 200 is present in the first section 205. In some examples, the membrane comprises at least one of: a polyolefin, a polyurethane, a polyester, a polyamide, a polyketone, polysulfones, or a polycarbonate. In some embodiments, the membrane can comprise a fluoropolymer. In some embodiments, the membrane comprises one or more of: PVDF, polyvinylidene difluoride, poly(tetrafluoroethylene-co-hexafluoropropylene (FEP), poly(ethylene-alt-tetrafluoroethylene) (ETFE), polychlorotrifluoroethylene (PCTFE), poly(tetrafluoroethylene-co-perfluoropropyl vinyl ether) (PFA), poly(vinylidene fluoride-co-hexafluoropropylene (PVDF-co-HFP), polyvinyl fluoride (PVF), or any combination thereof.

In some examples, the at least one portion of the cannabis flavoring device 200 infused with the at least one flavoring agent comprises at least one substrate 210. In some examples, the at least one substrate 210 comprises a sponge, a garment, a towel, wood, charcoal, pumice, steel wool, paper, or any combination thereof.

In some examples, the infused at least one portion comprises at least one surface of the at least one flavoring device 200. Some examples of the cannabis reflavoring process further include coating at least a portion of the at least one surface with the at least one flavoring agent, impregnating at least a portion of the at least one surface with the at least one flavoring agent, or some combination thereof. In some examples, the cannabis plant matter 225 is present on a surface of the flavoring device 200 that is not coated or impregnated with the at least one flavoring agent.

In some examples, the infusing at least one portion of the cannabis flavoring device 200 with the at least one flavoring agent comprises attaching an insert to at least one surface of the flavoring device 200, the insert comprises the at least one flavoring agent, and the insert is configured to release the essence of the at least one flavoring agent 230.

In some examples, the cannabis flavoring device 200 comprises a housing and at least one porous liner. In some examples, the housing is configured to house the deflavored cannabis plant matter 225 and the at least one porous liner is present on at least one side wall of the cannabis flavoring device 200, a top surface of the cannabis flavoring device 200, a bottom surface of the cannabis flavoring device 200, or any combination thereof. In some embodiments, the at least one porous liner is configured to be infused with at least one flavoring agent. In some embodiments, the at least one porous liner is configured to prevent the cannabis plant matter 225 from directly contacting the at least one flavoring agent, and the at least one porous liner allows the cannabis plant matter 225 to absorb the essence of the flavoring agent.

Some examples of the cannabis reflavoring process further include coating at least one porous liner with the at least one flavoring agent, impregnating the at least one porous liner with the at least one flavoring agent, or any combination thereof. Some examples further include allowing the deflavored cannabis plant matter 225 to absorb an essence of the at least one flavoring agent 230 while the at least one porous liner prevents the deflavored cannabis plant matter 225 from directly contacting the at least one flavoring agent. In some examples, the at least one porous liner comprises a membrane, a coffee filter, perforated paper, a mesh, a fabric, or any combination thereof.

Some examples of the cannabis reflavoring process further include coating at least a portion of the at least one substrate 210 with the at least one flavoring agent, impregnating at least a portion of the at least one substrate 210 with the at least one flavoring agent, or any combination thereof. Some examples further include placing the at least one substrate 210 in the first section 205 of the flavoring device 200.

Some examples of the cannabis reflavoring process that utilize the cannabis flavoring device 200 include placing the deflavored cannabis plant matter 225 into the second section 220. Some examples further include maintaining the deflavored cannabis plant matter 225 within the second section 220 for a sufficient time to allow an essence of the at least one flavoring agent 230 to diffuse from the first section 205 to the second section 220 without the at least one flavoring agent directly contacting the deflavored cannabis plant matter 225.

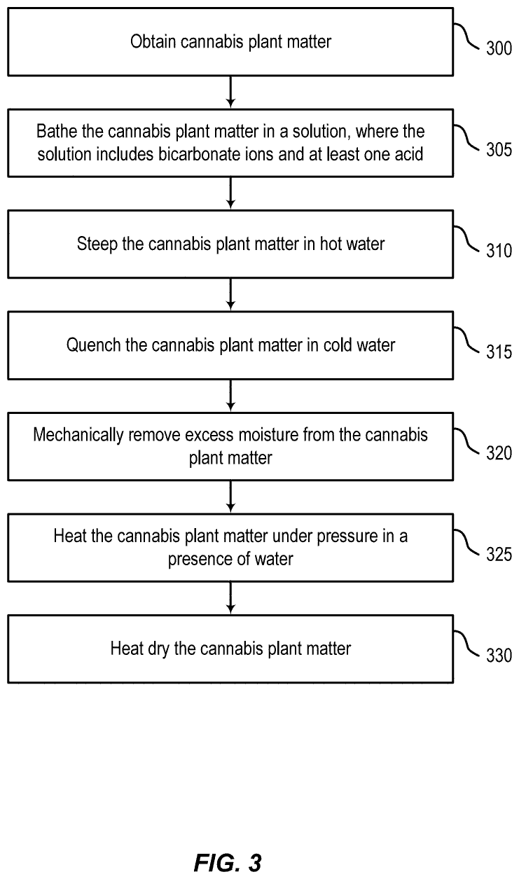

FIG. 3 shows an example of a cannabis deflavoring process or a cannabis deflavoring stage of a cannabis deflavoring and reflavoring process according to aspects of the present disclosure. At operation 300, the system obtains cannabis plant matter. At operation 305, the system bathes the cannabis plant matter in a solution, where the solution includes bicarbonate ions and at least one acid. In some cases, the operations of this step refer to, or may be performed by, a vessel or mixer. At operation 310, the system steeps the cannabis plant matter in hot water. In some cases, the operations of this step refer to, or may be performed by, a hot water vessel or boiler. At operation 315, the system quenches the cannabis plant matter in cold water. In some cases, the operations of this step refer to, or may be performed by, a cold water vessel or ice bath. At operation 320, the system mechanically removes excess moisture from the cannabis plant matter. In some cases, the operations of this step refer to, or may be performed by, an air dryer, a centrifuge, or a filter. At operation 325, the system heats the cannabis plant matter under pressure in a presence of water. In some cases, the operations of this step refer to, or may be performed by, a pressure cooker. At operation 330, the system heats drying the cannabis plant matter. In some cases, the operations of this step refer to, or may be performed by, an oven.

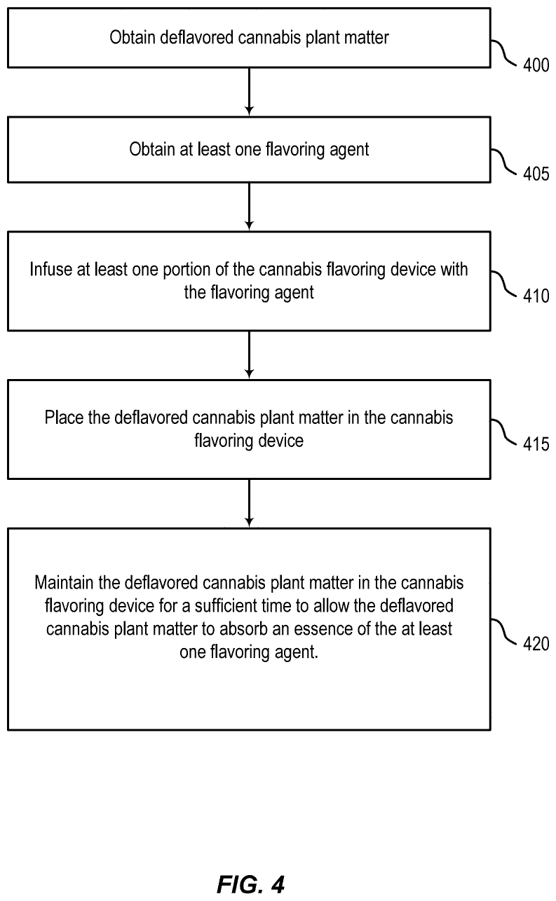

FIG. 4 shows an example of a cannabis reflavoring process or a cannabis reflavoring stage of a cannabis deflavoring and reflavoring process according to aspects of the present disclosure according to aspects of the present disclosure. At operation 400, the system obtains deflavored cannabis plant matter. At operation 405, the system obtains at least one flavoring agent. At operation 410, the system infuses at least one portion of the cannabis flavoring device with the flavoring agent. In some cases, the operations of this step refer to, or may be performed by, a coating device or injection device. At operation 415, the system places the deflavored cannabis plant matter in the cannabis flavoring device. In some cases, the operations of this step refer to, or may be performed by, a carrying device, a gripping device, or manually by a user of the cannabis flavoring device. At operation 420, the system maintains the deflavored cannabis plant matter in the cannabis flavoring device for a sufficient time to allow the deflavored cannabis plant matter to absorb an essence of the at least one flavoring agent. In some cases, the operations of this step refer to, or may be performed by, a cannabis flavoring device as described with reference to FIGS. 1 and 2.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures. Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein. In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

1. A cannabis deflavoring process comprising:
obtaining cannabis plant matter;
bathing the cannabis plant matter in a solution, where the solution comprises bicarbonate ions and at least one acid;
steeping the cannabis plant matter in hot water;
quenching the cannabis plant matter in cold water;
mechanically removing excess moisture from the cannabis plant matter;
heating the cannabis plant matter under pressure in a presence of water; and
heat drying the cannabis plant matter.

2. The cannabis deflavoring process of claim 1, further comprising, prior to bathing the cannabis plant matter in the solution, soaking or rinsing the cannabis plant matter in room temperature water.

3. The cannabis deflavoring process of claim 1, further comprising forming the solution by:
mixing water with the at least one acid, thereby forming a mixture; and
adding a bicarbonate salt to the mixture.

4. The cannabis deflavoring process of claim 1, further comprising forming the solution by:
mixing water with a bicarbonate salt, thereby forming a mixture; and
adding at least one acid to the mixture.

5. The cannabis deflavoring process of claim 1, further comprising forming the solution by mixing water with the at least one acid and a bicarbonate salt.

6. The cannabis deflavoring process of claim 1, where the cannabis plant matter is transferred directly from the hot water to the cold water.

7. The cannabis deflavoring process of claim 1, where mechanically removing excess moisture from the cannabis plant matter comprises agitating the cannabis plant matter, hand drying the cannabis plant matter, air drying the cannabis plant matter, or any combination thereof.

8. The cannabis deflavoring process of claim 1, where mechanically removing excess moisture from the cannabis plant matter is also performed during the bathing, after the bathing, or any combination thereof.

9. The cannabis deflavoring process of claim 1, where heating the cannabis plant matter under pressure in the presence of water comprises:
obtaining a vessel, where the vessel comprises a chamber and a porous barrier;
adding water to the chamber of the vessel;
adding the cannabis plant matter to the vessel, such that the cannabis plant matter is separated from the water by the porous barrier;
heating the vessel to an operating temperature;
pressurizing the vessel to an operating pressure;
maintaining the vessel at the operating pressure for a predetermined time period;
releasing pressure from the vessel; and
removing the cannabis plant matter from the vessel.

10. The cannabis deflavoring process of claim 1, where heat drying the cannabis plant matter is performed at a temperature sufficient to decarboxylate the cannabis plant matter.

11. The cannabis deflavoring process of claim 1, further comprising dissolving the deflavored cannabis plant matter in at least one solvent.

12. A cannabis reflavoring process comprising:
obtaining deflavored cannabis plant matter;
obtaining at least one flavoring agent;
infusing at least one portion of the cannabis flavoring device with the flavoring agent;
placing the deflavored cannabis plant matter in the cannabis flavoring device; and
maintaining the deflavored cannabis plant matter in the cannabis flavoring device for a sufficient time to allow the deflavored cannabis plant matter to absorb an essence of the at least one flavoring agent,
where the deflavored cannabis plant matter does not directly contact the at least one flavoring agent.

13. The cannabis reflavoring process of claim 12, where the cannabis flavoring device comprises a porous separator, where the porous separator divides the cannabis flavoring device into a first section and a second section.

14. The cannabis reflavoring process of claim 12, where the infused at least one portion comprises at least one surface of the at least one flavoring device; and
where the cannabis reflavoring process further comprises:
coating at least a portion of the at least one surface with the at least one flavoring agent;
impregnating at least a portion of the at least one surface with the at least one flavoring agent; or
any combination thereof.

15. The method of claim 12, where the flavoring device comprises a material having a water permeability ranging from 1×10⁻⁸ cm²/s to 1×10⁻⁶ cm²/s at 30° C.

16. The cannabis reflavoring process of claim 12, where the at least one flavoring agent comprises at least one essential oil, amyl acetate, benzaldehyde, ethyl butyrate, methyl anthranilate, methyl salicylate, fumaric acid, or any combination thereof.

17. The cannabis reflavoring process of claim 12, where infusing at least one portion of the cannabis flavoring device with the at least one flavoring agent comprises attaching an insert to at least one surface of the flavoring device,
where the insert comprises the at least one flavoring agent, and
where the insert is configured to release the essence of the at least one flavoring agent.

18. The cannabis reflavoring process of claim 12, where the cannabis flavoring device comprises:
a housing, where the housing is configured to house the deflavored cannabis plant matter; and
at least one porous liner, where the at least one porous liner is present on:
at least one side wall of the cannabis flavoring device,
a top surface of the cannabis flavoring device,
a bottom surface of the cannabis flavoring device, or
any combination thereof;
where the cannabis reflavoring process further comprises:
coating the least one porous liner with the at least one flavoring agent;
impregnating the at least one porous liner with the at least one flavoring agent; or
any combination thereof; and
allowing the deflavored cannabis plant matter to absorb an essence of the at least one flavoring agent while the at least one porous liner prevents the deflavored cannabis plant matter from directly contacting the at least one flavoring agent.

19. The cannabis reflavoring process of claim 12, where the cannabis flavoring device is ultraviolet (UV) resistant.

20. A cannabis deflavoring and reflavoring process comprising:
a deflavoring stage comprising:
obtaining cannabis plant matter;
bathing the cannabis plant matter in a solution, where the solution comprises bicarbonate ions and at least one acid;
steeping the cannabis plant matter in hot water;
quenching the cannabis plant matter in cold water;
mechanically removing excess moisture from the cannabis plant matter;
heating the cannabis plant matter under pressure in a presence of water; and
heat drying the cannabis plant matter;
where the deflavoring stage results in deflavored cannabis; and
a reflavoring stage comprising:
obtaining the deflavored cannabis plant matter;
obtaining at least one flavoring agent;
infusing at least one portion of the cannabis flavoring device with the at least one flavoring agent;
placing the deflavored cannabis plant matter in the cannabis flavoring device; and
maintaining the deflavored cannabis plant matter in the cannabis flavoring device for a sufficient time to allow the deflavored cannabis plant matter to absorb an essence of the at least one flavoring agent;
where the deflavored cannabis plant matter does not directly contact the at least one flavoring agent during the cannabis reflavoring stage.
